(19) United States
(12) Patent Application Publication
(10) Pub. No.: US 2026/0004210 A1
(43) Pub. Date: Jan. 1, 2026

(54) DETERMINING AN EFFECTIVE STORAGE CAPACITY OF AN UNCONVENTIONAL SUBSURFACE VOLUME OF INTEREST AS A FUNCTION OF POSITION

(71) Applicant: CHEVRON U.S.A. INC., San Ramon, CA (US)

(72) Inventors: David James Robbins, Sacramento, CA (US); Shane James Prochnow, Fredericksburg, TX (US); Stephen Daniel Yow, Conroe, TX (US)

(21) Appl. No.: 18/761,003

(22) Filed: Jul. 1, 2024

(51) Int. Cl. G06Q 10/0631; G06Q 10/04

(52) U.S. Cl. CPC G06Q 10/06315; G06Q 10/04

(57) ABSTRACT

Method, systems, and non-transitory computer readable media for determining an effective storage capacity of an unconventional subsurface volume of interest as a function of position are disclosed. Some implementations may include: obtaining historical production data correlating to the unconventional subsurface volume of interest, obtaining subsurface reservoir data correlating to the unconventional subsurface volume of interest, obtaining an initial storage capacity model comprising initial forecast production data, adjusting the initial forecast production data using the historical production data, the subsurface reservoir data, or both to generate the effective storage capacity data of the unconventional subsurface volume of interest, generating a graphical representation of the effective storage capacity of the unconventional subsurface volume of interest as a function of position using visual effects to depict at least a portion of the effective storage capacity data, and displaying the graphical representation in the graphical user interface.

### FIELD OF THE DISCLOSURE

The present disclosure relates to determining an effective storage capacity of an unconventional subsurface volume of interest as a function of position.

### BACKGROUND

Existing approaches for storage capacity estimates, such as for carbon, typically require complex geological and reservoir simulation models to be constructed that are time consuming to generate, limit the amount of a basin that may be handled, computationally intensive, etc. A need exists in the area of determining storage capacity.

### SUMMARY

Implementations of the disclosure are directed to determining an effective storage capacity of a unconventional subsurface volume of interest as a function of position.

An aspect of the present disclosure relates to a method for determining an effective storage capacity of an unconventional subsurface volume of interest as a function of position. The method may be implemented in a computer system that includes a physical computer processor, a graphical user interface, and a non-transitory storage medium. The method may include a number of steps. One step may include obtaining historical production data correlating to the unconventional subsurface volume of interest from the non-transitory storage medium, wherein the historical production data correlates to an amount of produced fluid as a function of position. Another step may include obtaining subsurface reservoir data correlating to the unconventional subsurface volume of interest from the non-transitory storage medium. Another step may include obtaining an initial storage capacity model comprising initial forecast production data correlating to the unconventional subsurface volume of interest from the non-transitory storage medium, wherein the initial storage capacity model comprising subsurface characterization parameters, wherein the subsurface characterization parameters correlate to reservoir characteristics of the unconventional subsurface volume of interest, and wherein the initial forecast production data correlates to a forecasted amount of produced fluid as a function of position. Another step may include adjusting, with the physical computer processor, the initial forecast production data of the initial storage capacity model using the historical production data, the subsurface reservoir data, or both to generate effective storage capacity data of the unconventional subsurface volume of interest as a function of position. Yet another step may include generating, with the physical computer processor, a graphical representation of the effective storage capacity of the unconventional subsurface volume of interest as a function of position using visual effects to depict a portion of the effective storage capacity data. Yet another step may include displaying the graphical representation in the graphical user interface.

In implementations, the initial storage capacity model is based on mobility, buoyancy, reservoir heterogeneity, water saturation, or any combination thereof.

In implementations, the subsurface reservoir data correlates to petrophysical and geochemical characteristics as a function of position.

In implementations, the subsurface characterization parameters comprise core-based data, petrophysical data, geochemical data, geophysical data, or any combination thereof.

In implementations, the reservoir characteristics comprise rock fluid data, pressure data, chemical property data, physical property data, or any combination thereof.

In implementations, the effective storage capacity data correlates to an available storage volume in the unconventional volume of interest as a function of position for carbon dioxide.

In implementations, the effective storage capacity data correlates to an available storage volume in the unconventional volume of interest as a function of position for a fluid storable in the unconventional subsurface volume of interest.

An aspect of the present disclosure relates to a system including a non-transitory storage medium. The system may also include a graphical user interface. The system may also include a physical computer processor configured by machine-readable instructions to perform a number of steps. One step may include obtaining historical production data correlating to an unconventional subsurface volume of interest from the non-transitory storage medium, wherein the historical production data correlates to an amount of produced fluid as a function of position. Another step may include obtaining subsurface reservoir data correlating to the unconventional subsurface volume of interest from the non-transitory storage medium. Another step may include obtaining an initial storage capacity model comprising initial forecast production data correlating to the unconventional subsurface volume of interest from the non-transitory storage medium, wherein the initial storage capacity model comprising subsurface characterization parameters, wherein the subsurface characterization parameters correlate to reservoir characteristics of the unconventional subsurface volume of interest, and wherein the initial forecast production data correlates to a forecasted amount of produced fluid as a function of position. Yet another step may include adjusting, with the physical computer processor, the initial forecast production data of the initial storage capacity model using the historical production data, the subsurface reservoir data, or both to generate effective storage capacity data of the unconventional subsurface volume of interest as a function of position. Yet another step may include generating, with the physical computer processor, a graphical representation of an effective storage capacity of the unconventional subsurface volume of interest as a function of position using visual effects to depict a portion of the effective storage capacity data. Yet another step may include displaying the graphical representation in the graphical user interface.

In implementations, the initial storage capacity model is based on reservoir heterogeneity, water saturation, or any combination thereof.

In implementations, the subsurface reservoir data correlates to petrophysical and geochemical characteristics as a function of position.

In implementations, the subsurface characterization parameters comprise core-based data, petrophysical data, geochemical data, geophysical data, or any combination thereof.

In implementations, the reservoir characteristics comprise rock fluid data, pressure data, chemical property data, physical property data, or any combination thereof.

In implementations, the effective storage capacity data correlates to an available storage volume in the unconventional volume of interest as a function of position for carbon dioxide.

In implementations, the effective storage capacity data correlates to an available storage volume in the unconventional volume of interest as a function of position for a fluid storable in the unconventional subsurface volume of interest.

An aspect of the present disclosure relates to a non-transitory computer-readable medium storing instructions for determining an effective storage capacity of an unconventional subsurface volume of interest as a function of position. The instructions may be configured to, when executed, perform a number of steps. One step may include obtaining historical production data correlating to the subsurface volume of interest from a non-transitory storage medium, wherein the historical production data correlates to an amount of produced fluid as a function of position. Another step may include obtaining subsurface reservoir data correlating to the unconventional subsurface volume of interest from the non-transitory storage medium. Yet another step may include obtaining an initial storage capacity model comprising initial forecast production data correlating to the unconventional subsurface volume of interest from the non-transitory storage medium, wherein the initial storage capacity model comprising subsurface characterization parameters, wherein the subsurface characterization parameters correlate to reservoir characteristics of the unconventional subsurface volume of interest, and wherein the initial forecast production data correlates to a forecasted amount of produced fluid as a function of position. Yet another step may include adjusting, with a physical computer processor, the initial forecast production data of the initial storage capacity model using the historical production data, the subsurface reservoir data, or both to generate effective storage capacity data of the unconventional subsurface volume of interest as a function of position. Yet another step may include generating, with the physical computer processor, a graphical representation of the effective storage capacity of the unconventional subsurface volume of interest as a function of position using visual effects to depict a portion of the effective storage capacity data. Yet another step may include displaying the graphical representation in a graphical user interface.

In implementations, the initial storage capacity model is based on mobility, buoyancy, reservoir heterogeneity, water saturation, or any combination thereof.

In implementations, the subsurface reservoir data correlates to petrophysical and geochemical characteristics as a function of position.

In implementations, the subsurface characterization parameters comprise core-based data, petrophysical data, geochemical data, geophysical data, or any combination thereof.

In implementations, the reservoir characteristics comprise rock fluid data, pressure data, chemical property data, physical property data, or any combination thereof.

In implementations, the effective storage capacity data correlates to an available storage volume in the unconventional volume of interest as a function of position for carbon dioxide.

In implementations, the effective storage capacity data correlates to an available storage volume in the unconventional volume of interest as a function of position for a fluid storable in the unconventional subsurface volume of interest.

These and other features, and characteristics of the present technology, as well as the methods of operation and functions of the related elements of structure and the combination of parts and economies of manufacture, will become more apparent upon consideration of the following description and the appended Claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the presently disclosed technology. As used in the specification and in the Claims, the singular form of “a”, “an”, and “the” include plural referents unless the context clearly dictates otherwise.

The technology disclosed herein, in accordance with one or more various implementations, is described in detail with reference to the following figures. The drawings are provided for purposes of illustration only and merely depict typical or example implementations of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 shows a system configured for determining an effective storage capacity of an unconventional subsurface volume of interest as a function of position, in accordance with one or more implementations.

FIG. 2 illustrates a method for determining an effective storage capacity of an unconventional subsurface volume of interest as a function of position, in accordance with one or more implementations.

FIG. 3 illustrates a representation of effective storage capacity of an unconventional subsurface volume of interest as a function of position, in accordance with one or more implementations.

FIG. 4 illustrates example computing component, in accordance with some implementations.

### DETAILED DESCRIPTION

Existing approaches for storage capacity estimates, such as for carbon, typically require complex geological and reservoir simulation models to be constructed that are time consuming to generate, limit the amount of a basin that may be handled, computationally intensive, etc. In contrast, the presently disclosed technology may determine an effective storage capacity of an unconventional subsurface volume of interest as a function of position. For example, the presently disclosed technology may estimate carbon storage potential in unconventional basins. The presently disclosed technology may generate basin-scale estimates of carbon storage. This approach can be loosely analogous to the inverse of the terminology used to encompass all quantities of petroleum (recoverable and unrecoverable) naturally occurring in an accumulation on or within the Earth's crust, discovered and undiscovered, plus those quantities already produced. Further, it can include all types of petroleum whether currently considered conventional or unconventional. It may also provide more granular estimates of potential zones that could be highly graded for carbon storage or enhanced oil recovery (EOR). Some examples of EOR include surfactant injection and/or gas injection, waterflooding, formation heating, etc. The presently disclosed technology may be able to look at a single basin, as well as an entire portfolio, which may enable a grading of storage opportunities and provide a basis for performing more detailed simulation work and/or other work to analyze the storage opportunities. The presently disclosed technology may be able to estimate a storage potential. The presently disclosed technology may also be used to rank storage opportunities.

Applied across several basins, the presently disclosed technology may estimate large storage opportunities. In implementations, the presently disclosed technology may utilize pressure-volume-temperature (PVT) estimates of the carbon fluid. PVT may also be used to convert the surface conditions to downhole conditions. For example, the presently disclosed technology may use estimated ultimate recovery, while CO₂ may be stored at a higher temperature and pressure in the unconventional subsurface volume of interest. Moreover, varying downhole conditions may be encoded at a reference pressure/temperature at a reference depth, which may then be corrected using pressure/temperature gradient values. The presently disclosed technology may also include geospatial masking to high-grade regions of greater estimated residence time of storage. This mask may be a convolution of using cut-off values of relevant geologic features and a k-nearest neighbors or any other clustering model. This mask may be applied to account for no-use flags for synthetic wells in the scoring grid that are located more than a certain distance from a nearby control point (i.e., a well within the training data set). In some implementations, a distance (e.g., from length of a well to radius of the unconventional formation, such as, but not limited to, about 10,000 feet-about 300,000 feet (e.g., about 10,000 feet-250,000 feet)) may be specified using semivariogram analysis. The presently disclosed technology may also allow users to generate estimates of acceptable storage duration.

Disclosed below are methods, systems, and computer readable storage media that may provide an effective storage capacity of an unconventional subsurface volume of interest as a function of position.

The term “subsurface volume of interest” may be used synonymously with the term “reservoir” or “subsurface reservoir” or “subsurface region of interest” or “formation” or “subsurface formation” or “subterranean formation”, or “subsurface region” or similar terminology. The subsurface volume of interest may also include a reservoir, a formation, or any combination thereof.

Each subsurface volume of interest may have a variety of characteristics conducive to storage, such as petrophysical rock properties, reservoir fluid properties, reservoir conditions, or any combination thereof. For example, each subsurface volume of interest may be associated with one or more of: temperature, porosity, permeability, water composition, mineralogy, hydrocarbon type, hydrocarbon quantity, reservoir location, pressure, etc. In one embodiment, the subsurface volume of interest may be shale and tight. In one embodiment, the subsurface volume of interest may be unconventional.

As used herein, in some embodiment, the unconventional subsurface volume of interest may have a permeability of nano to millidarcy permeability, such as, but not limited to, less than 0.1 millidarcy. As used herein, in some embodiments, the unconventional subsurface volume of interest may have a permeability of less than 0.1 millidarcy (mD) (e.g., 0.05 mD or less, 0.01 mD or less, 0.005 mD or less, 0.001 mD or less, 0.0005 mD or less, 0.0001 mD or less, 0.00005 mD or less, 0.00001 mD or less, 0.000005 mD or less, or 0.000001 mD or less). As used herein, in some embodiments, the unconventional subsurface volume of interest may have a permeability of at least 0.0000001 mD (e.g., at least 0.000005 mD, at least 0.00001 mD, 0.00005 mD, at least 0.0001 mD, 0.0005 mD, 0.001 mD, at least 0.005 mD, at least 0.01 mD, or at least 0.05 mD). The unconventional subsurface volume of interest have a permeability ranging from any of the minimum values described above to any of the maximum values described above. As used herein, in some embodiments, the unconventional subsurface volume of interest have a permeability of from 0.0000001 mD to 0.1 mD e.g., from 0.0000001 mD to 0.001 mD or 0.0000001 mD to 0.01 mD).

The term “carbon dioxide” and “a fluid storable in the unconventional subsurface volume of interest” as used herein may be injected in a gas phase, a liquid phase, or any combination thereof into the unconventional subsurface volume of interest. In one embodiment, carbon dioxide may be injected in a gas phase. In one embodiment, carbon dioxide may be injected in a liquid phase. In one embodiment, carbon dioxide may be injected in a gas phase and a liquid phase combination. In one embodiment, fluid storable in the unconventional subsurface volume of interest (e.g., methane, produced water such as in the context of a saltwater disposal well, natural gas, nitrogen, etc.) may be injected in a gas phase. In one embodiment, fluid storable in the unconventional subsurface volume of interest (e.g., methane, produced water such as in the context of a saltwater disposal well, natural gas, nitrogen, etc.) may be injected a liquid phase. In one embodiment, fluid storable in the unconventional subsurface volume of interest (e.g., methane, produced water such as in the context of a saltwater disposal well, natural gas, nitrogen, etc.) may be injected in a gas phase and a liquid phase combination.

The term “produced water” as used herein may include, but it not limited to, sea water, brackish water, flowback or produced water, wastewater (e.g., reclaimed or recycled), brine (e.g., reservoir or synthetic brine), fresh water (e.g., fresh water comprises<1,000 ppm TDS), any other type of water, or any combination thereof. Reference will now be made in detail to various implementations, examples of which are illustrated in the accompanying drawings. In the following detailed description, numerous details may be set forth in order to provide a thorough understanding of the present disclosure and the implementations described herein. However, implementations described herein may be practiced without such details. In other instances, some methods, procedures, components, and mechanical apparatuses may not be described in detail, so as not to unnecessarily obscure aspects of the implementations.

The presently disclosed technology includes implementations of a method, system, and non-transitory computer-readable medium for determining an effective storage capacity of an unconventional subsurface volume of interest as a function of position. The unconventional subsurface volume of interest may include, or be bounded by, one or more of a water surface, a ground surface, and/or other surfaces. The presently disclosed technology may adjust initial forecast production data of an initial storage capacity model using historical production data, subsurface reservoir data, or both to generate effective storage capacity data of the unconventional subsurface volume of interest as a function of position. A graphical representation of the effective storage capacity of the unconventional subsurface volume of interest as a function of position may be generated using visual effects and displayed in a graphical user interface.

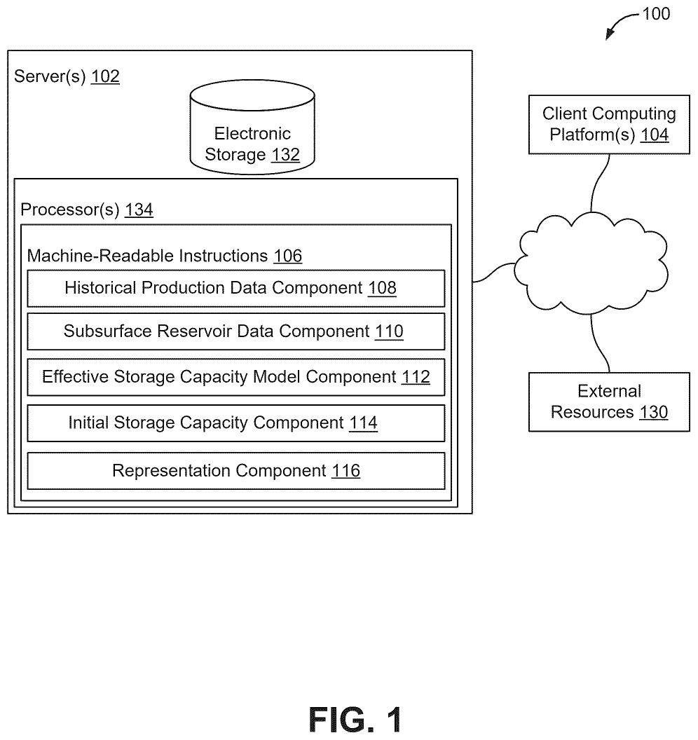

FIG. 1 illustrates a system 100 configured for determining an effective storage capacity of an unconventional subsurface volume of interest as a function of position, in accordance with one or more implementations. In some implementations, system 100 may include one or more servers 102. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may be configured by machine-readable instructions 106. Machine-readable instructions 106 may include one or more instruction components. The instruction components may include computer program components. The instruction components may include one or more of a historical production data component 108, a subsurface reservoir data component 110, an initial storage capacity model component 112, an effective storage capacity component 114, a representation component 116, and/or other instruction components.

Historical production data component 108 may be configured to obtain historical production data. The historical production data may be obtained from the non-transitory storage medium and/or other sources. The historical production data may correlate to an amount of produced fluid from the unconventional subsurface volume of interest as a function of position. The produced fluid may be carbon dioxide, produced water, methane, natural gas, nitrogen, and/or another fluid that is produced from the unconventional subsurface volume of interest. In some implementations, the historical production data may correlate to an amount of a produced gas. In implementations, the historical production data may characterize the amount of hydrocarbons that have been extracted from a well. The historical production data may include cumulative production values, historical production values, and/or other types of production values of the unconventional subsurface volume of interest as a function of position. The historical production data may include values correlating to cumulative oil, gas, and/or water production at different time intervals, such as, for example, 6 months, 12 months, 18 months, or estimated ultimate recovery (EUR) and so on. Historical production data may include corresponding geographical coordinates, x-y coordinates, and/or other location information.

Subsurface reservoir data component 110 may be configured to obtain subsurface reservoir data. The subsurface reservoir data may be obtained from the non-transitory storage medium and/or other sources. The subsurface reservoir data may correlate to the unconventional subsurface volume of interest. The subsurface reservoir data may correlate to petrophysical and geochemical characteristics of the unconventional subsurface volume of interest as a function of position. Example petrophysical characteristics may include fracture closure stress, mineralogy, porosity, hydrocarbon thermal maturity, and/or pore saturation. Example geochemical characteristics may include water chemistry, total dissolved solids (TDS), PH values, etc., Subsurface reservoir data may include corresponding geographical coordinates, x-y coordinates, and/or other location information.

Initial storage capacity model component 112 may be configured to obtain an initial storage capacity model that includes initial forecast production data correlating to the unconventional subsurface volume of interest. The initial storage capacity model may be obtained from the non-transitory storage medium and/or other sources. The initial storage capacity model may include subsurface characterization parameters. The subsurface characterization parameters may correlate to reservoir characteristics of the unconventional subsurface volume of interest. The subsurface characterization parameters comprise core-based data, petrophysical data, geochemical data, geophysical data, or any combination thereof. For example, the subsurface characterization parameters may include core-based data, petrophysical data, geochemical data, and/or geophysical data. The reservoir characteristics comprise rock fluid data, pressure data, chemical property data, physical property data, or any combination thereof. For example, the reservoir characteristics may include rock fluid data, pressure data, chemical property data, and/or physical property data.

The initial forecast production data may correlate to a forecast amount of produced fluid of the unconventional subsurface volume of interest as a function of position. The produced fluid may be carbon dioxide, produced water, methane, natural gas, nitrogen, and/or another fluid that may be produced from the unconventional subsurface volume of interest. In some implementations, the initial forecast production data may correlate to an amount of forecast gas production. In implementations, the initial forecast production data may characterize the forecast amount of hydrocarbons that may be extracted from a well. The initial forecast production data may include forecast cumulative production values, forecast production values, and other types of forecast production values of the unconventional subsurface volume of interest as a function of position. The initial forecast production data may include values correlating to forecast cumulative oil, gas, and/or water production at different time intervals, such as, for example, 6 months, 12 months, 18 months, or forecast estimated ultimate recovery (EUR) and so on. Initial forecast production data may include corresponding geographical coordinates, x-y coordinates, and/or other location information.

In implementations, the initial storage capacity model is based on mobility, buoyancy, reservoir heterogeneity, water saturation, or any combination thereof. For example, the initial storage capacity model may be generated based on mobility, buoyancy, reservoir heterogeneity, and/or water saturation. In some implementations, the initial storage capacity model may use confidence masking based on distance from a nearest control point and/or geological parameter cut-offs. Confidence masking is a procedure to eliminate geographic regions of the study area that should not be used to predict CO₂ (or other fluid) storage potential adequately. The “masks” may be map based polygon regions where the multiple geologic/geographic predictors for the CO₂ (or other fluid) storage have large uncertainty in their projection. As an example, when the mean estimate of these geologic/geographic predictors is greater than the mean prediction, it may become a masked area. As an example, the occurrence of these geologic predictors may be projected using a geographic distribution of discrete samples (data wells) and a mathematical function may be used to interpolate those samples across a hydrocarbon producing basin area. The interpolation has an uncertainty that increases with distance away from the sample points. Masked areas might also include regions where the geologic predictors for CO₂ (or other fluid) storage in a machine learning model have values outside of the range of samples used to make the machine learning model to predict CO₂ (or other fluid).

In implementations, the initial storage capacity model may be based on a void space parameter, an adsorption parameter, a dissolution parameter, a miscible partition parameter, a diffusion parameter, a migration parameter, or any combination thereof. For example, the initial storage capacity model may be based on a void space parameter, an adsorption parameter, a dissolution parameter, a miscible partition parameter, a diffusion parameter, and/or a migration parameter. One or more of these parameters may also be based on machine learning. The initial storage capacity model may be built using the systems described in U.S. Pat. Nos. 11,313,993, 11,221,427, 11,092,715, 11,423,197, 11,371,336, and/or 11,506,813, each of which is incorporated by reference herein. For instance, various parameters may be used to build the initial storage capacity model having initial forecast production data using machine learning methods, in other words, a forecast model for production that predicts the likely production achievable from the unconventional subsurface volume of interest as a function of position may be built using machine learning. The effective storage capacity data, such as the storage volume of the unconventional subsurface volume of interest, may be derived by subtracting the historical production from the forecasted production data of the machine learning initial storage capacity model. This adjustment by subtraction is described further in connection with the effective storage capacity component 114.

Turning to the subsurface characterization parameters, the void space parameter may indicate the void space from net fluid production. A machine learning model may be used to predict the original producible fluid volume residing in the unconventional subsurface volume of interest. This machine learning model may apply a variety of geologic variables to predict the original producible fluid volume. The void space may be calculated as the difference between the estimate of original producible fluid volume residing in the unconventional subsurface volume of interest from this machine learning model and the volume of fluid (oil, gas, and water) subsequently and physically produced from the unconventional subsurface volume of interest using at least one well from the historical production data. The void space parameter may vary depending on the composition of the fluid.

The adsorption parameter may indicate the adsorption of CO₂ and/or other fluid to the mineral surface. The fluid may have varying electrochemical affinities for the different minerals that compose the host rock of the unconventional subsurface volume of interest. For example, map or model based mineralogy estimates of the unconventional subsurface volume of interest may be used to adjust how much CO₂ may be stored in the void space within the partially produced unconventional subsurface volume of interest. The adsorption parameter may vary depending on the composition of the fluid.

The dissolution parameter may indicate the CO₂ and/or other fluid's dissolution into residual formation water of the unconventional subsurface volume of interest. Formation water (trapped in the pores of sedimentary rocks) may be found in the unconventional subsurface volume of interest. The formation water is bound to the pore space within the host rock of the unconventional subsurface volume of interest. For example, CO₂ may dissolve and be stored in this formation water. The dissolution parameter may indicate how CO₂ dissolves in this formation water. The dissolution parameter may vary depending on the composition of the fluid.

The miscible partition parameter may indicate how the CO₂ and/or other fluid enters residual hydrocarbon in the unconventional subsurface volume of interest. Liquid hydrocarbon found in the unconventional subsurface volume of interest may bind to the pore space within the host rock of the unconventional subsurface volume of interest. For example, CO₂ may dissolve and be stored in this liquid hydrocarbon. The miscible partition parameter may define how the CO₂ dissolves in the liquid hydrocarbon, whereas the diffusion parameter may indicate the CO₂'s diffusion into the formation water of the unconventional subsurface volume of interest. The diffusion pathways of CO₂ (or other chemicals) into the formation water can be dependent on the electrochemical behavior of the species, pressure, and temperature of the formation water. Additionally, the pressure and temperature can change based on the reservoir's depth. The diffusion parameter can account for any of the above diffusion properties or changes in the diffusion properties as tailored to a particular reservoir. CO₂ and other potentially stored fluid may slowly distribute themselves through diffusion to increase the entropy of the system. This CO₂ may migrate from the unconventional subsurface volume of interest into the adjacent hydrocarbon producing reservoir and be stored in a dissolved state within the water of that hydrocarbon producing reservoir. The miscible parameter may vary depending on the composition of the fluid.

The diffusion parameter may define how CO₂ and/or other fluid diffuses into the formation water of the unconventional subsurface volume of interest. For example, CO₂ may be more buoyant than formation water, depending on the temperature and pressure. In this buoyant state, the CO₂ may follow the same vertical and lateral pathways that migrating hydrocarbon will take in the subsurface. Carbon dioxide has a diffusion coefficient of 0.0016 mm²/s in formation water based on a diffusion coefficient known in the art. Diffusivity has dimensions of length²/time, or m²/s in SI units and cm²/s in CGS units. Other diffusion coefficients based on other equations known in the art may be utilized in some implementations. The diffusion parameter may vary depending on the composition of the fluid, and the diffusion parameter may be based on entropy.

The migration parameter may define how CO₂ and/or other fluid may potentially migrate to overlying stratigraphy, such as, but not limited to, a hydrocarbon producing reservoir adjacent to the unconventional subsurface volume of interest. The migration routine may be performed incrementally at key geologic surfaces (e.g., geologic surfaces that have a sealing function) and represent a grid-based assessment of inverse drainage accumulation where more buoyant chemical species naturally flow across the unconventional subsurface volume of interest. The migration parameter may vary depending on the composition of the fluid, and the migration parameter may be based on separation (e.g., separation based on density).

In some implementations, the initial storage capacity model may be generated using existing quasi-subjective methods as known to a person of ordinary skill in the art. In implementations, the initial storage capacity model may include an unsupervised machine learning model. The unsupervised machine learning model may include adjustable hyperparameters. In some implementations, the initial storage capacity model may be based on a hydrocarbon offtake, a net water offtake, an amount of fluid dissolved in water, an amount of fluid dissolved in remaining hydrocarbon phase, an amount of fluid adsorbed to a mineral surface, mobility, buoyancy, reservoir heterogeneity, water saturation, void space, miscible partition, diffusion, migration, pressure, volume, temperature, depth, distance from a control point, and/or cut-off values as examples of some adjustable hyperparameters, though it should be appreciated that there are other adjustable hyperparameters. The presently disclosed technology may use statistical methods to provide confidence levels.

In implementations, the initial storage capacity model may include a PVT model. The PVT model may be based on determining carbon PVT properties, generating storage duration, generating carbon storage volumes, and/or creating confidence masks for filtering estimates. The PVT model may use a reference pressure, a reference depth, a reference temperature, a maximum distance from a control point, a cut-off value, and/or an adjustable set of parameters. In implementations, there may be an initial storage capacity model. The initial storage capacity model may be obtained from the non-transitory storage medium and/or another source. The initial storage capacity model may be based on at least machine learning techniques to map at least one variable to at least another variable. For example, the initial storage capacity model may receive well data, production data, subsurface reservoir data, effective storage capacity data, and/or other data as input and output data. In implementations, storage estimates from the initial storage capacity model may be used iteratively to refine the model. That is, as estimates are generated, the model can adapt to account for changes in physics based processes associated with the data (i.e., adjustments in diffusion due to temperature and/or pressure changes). In implementations, the initial storage capacity model may be “untrained” or “unconditioned,” indicating it may not estimate an output based on at least the input as accurately as a “trained” or “conditioned” model.

In some implementations, the initial storage capacity model may include one or more components of a gradient boost regression, a random forest, a neural network, a regression, and/or other machine learning techniques. It should be appreciated that other initial storage capacity models may include, for example, convolutional neural networks, reinforcement learning, transfer learning, and/or other machine learning techniques. The initial storage capacity model may be trained using training data. The training data may include training well data, training historical production data, training subsurface reservoir data, training effective storage capacity data, and/or other data. The training data may be derived from seismic data, historic data, well data, and/or other data. The seismic data may be collected from multiple seismic data sites/surveys (i.e., on a pad or regional scale) and correspond to different geophysical collection methods (i.e., 2D seismic, 3D seismic, multicomponent 3D seismic, time-lapse (4D) seismic, microseismic, VSP, and the like).

Training the initial storage capacity model may include applying the initial effective storage capacity model to the training data to generate a first iteration of effective storage capacity data. The initial storage capacity model may be adjusted to more accurately estimate the effective storage capacity data based on at least the corresponding accuracy values for the effective storage capacity data. For example, adjustable hyperparameters may be adjusted after individual iterations of the initial storage capacity model. This is repeated numerous times until the initial storage capacity model is “trained,” i.e., it is able to output effective storage capacity data that are consistently within a threshold of the accuracy value. In some implementations, the threshold value may account for the speed of the effective storage capacity model, resources used by the effective storage capacity model, and/or other optimization metrics. This threshold may be based on at least an average of values, a minimum of values, a maximum of values, and/or other parameters. Other metrics may be applied to determine that the effective storage capacity model is “conditioned” or “trained.” As an example, the threshold may be with 5% of the accuracy value, though it should be appreciated that the threshold may be 10%, 15%, 25%, and so on.

In implementations, training the initial storage capacity model may include generating synthetic effective storage capacity data and/or other data from existing assets. Training may also include deriving training data from existing assets. Training may also include validating the trained model by using testing data. The testing data may be well data, historical production data, subsurface reservoir data, and/or other data that is not a part of the training data. Training may also include applying the initial storage capacity model to the testing data to generate effective storage capacity data. Training may also include determining accuracy values for the effective storage capacity data.

The initial storage capacity model may be able to predict effective storage capacity data by recognizing patterns in the training data. In implementations, the various input data, including, for example, any adjustable hyperparameters, may be weighted differently. As another example, different types of subsurface reservoir data and/or historical production data may be weighted differently.

The effective storage capacity component 114 may be configured to generate effective storage capacity data. This may be accomplished by a physical computer processor. The effective storage capacity data may be generated by adjusting the initial forecast production data of the initial storage capacity model using the historical production data, the subsurface reservoir data, or both. The effective storage capacity data may be generated by subtracting the historical production data from the forecasted production data. This is an example of adjustment by subtraction. The mean, pre-production resource potential from a hydrocarbon producing field of interest may be forecasted using a machine learning that is trained to forecast estimated ultimate recovery (EUR). EUR can be derived from decline curve analysis (DCA). The actual produced hydrocarbon and fluid history of basin can then be subtracted from the mean EUR productions and the difference can be mathematically converted to an initial storage volume capacity.

The effective storage capacity data correlates to an available storage volume of the unconventional subsurface volume of interest as a function of position. For example, the effective storage capacity data correlates to an available storage volume in the unconventional volume of interest as a function of position for carbon dioxide. For example, the effective storage capacity data correlates to an available storage volume in the unconventional volume of interest as a function of position for a fluid storable in the unconventional subsurface volume of interest. In one embodiment, the available storage volume is for carbon dioxide injected in a gas phase, a liquid phase, or both. In one embodiment, the available storage volume is for a fluid storable in the unconventional subsurface volume of interest (e.g., methane, produced water such as in the context of a saltwater disposal well, natural gas, nitrogen, etc.) injected in a gas phase, a liquid phase, or both. The effective storage capacity data may include corresponding geographical coordinates, x-y coordinates, and/or other location information.

Representation component 116 may be configured to generate a graphical representation of the effective storage capacity of the unconventional subsurface volume of interest as a function of position using visual effects to depict at least a portion (e.g., some or all) of the effective storage capacity data. In some implementations, a visual effect may include a visual transformation of the graphical representation. A visual transformation may include a visual change in how the graphical representation is presented or displayed. In some implementations, a visual transformation may include a visual zoom, a visual filter, a visual rotation, and/or a visual overlay (e.g., text and/or graphics overlay). The visual effect may include using a “temperature map,” or other color coding, to indicate which positions in the unconventional subsurface volume of interest have higher or lower values. It should be appreciated that graphical representations of basin-wide estimates of carbon (or other fluid) storage potential may be generated in addition to geospatial maps of storage and duration potential, including both absolute and normalized storage potential by completion length.

Representation component 116 may be configured to display the graphical representation. The graphical representation may be displayed on a graphical user interface and/or other displays.

In some implementations, server(s) 102, client computing platform(s) 104, and/or external resources 130 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 130 may be operatively linked via some other communication media.

A given client computing platform 104 may include one or more processors configured to execute computer program components. The computer program components may be configured to enable an expert or user associated with the given client computing platform 104 to interface with system 100 and/or external resources 130, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 130 may include sources of information outside of system 100, external entities participating with system 100, and/or other resources. In some implementations, some or all of the functionality attributed herein to external resources 130 may be provided by resources included in system 100.

Server(s) 102 may include electronic storage 132, one or more processors 134, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 132 may comprise non-transitory storage medium and/or non-transitory storage media that electronically stores information. The electronic storage media of electronic storage 132 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 132 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 132 may include one or more virtual storage resources (e.g., cloud storage, a virtual private network, and/or other virtual storage resources). Electronic storage 132 may store software algorithms, information determined by processor(s) 134, information received from server(s) 102, information received from client computing platform(s) 104, and/or other information that enables server(s) 102 to function as described herein.

Processor(s) 134 may be configured to provide information processing capabilities in server(s) 102. As such, processor(s) 134 may include one or more of a physical computer processor, a digital processor, an analog processor, a digital circuit designed to process information, an analog circuit designed to process information, a state machine, and/or other mechanisms for electronically processing information. Although processor(s) 134 is shown in FIG. 1 as a single entity, this is for illustrative purposes only. In some implementations, processor(s) 134 may include a plurality of processing units. These processing units may be physically located within the same device, or processor(s) 134 may represent processing functionality of a plurality of devices operating in coordination. Processor(s) 134 may be configured to execute components 108, 110, 112, 114, 116, and/or other components. Processor(s) 134 may be configured to execute components 108, 110, 112, 114, 116, and/or other components by software; hardware; firmware; some combination of software, hardware, and/or firmware; and/or other mechanisms for configuring processing capabilities on processor(s) 134. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, 114, and/or 116 are illustrated in FIG. 1 as being implemented within a single processing unit, in implementations in which processor(s) 134 includes multiple processing units, one or more of components 108, 110, 112, 114, and/or 116 may be implemented remotely from the other components. The description of the functionality provided by the different components 108, 110, 112, 114, and/or 116 described below is for illustrative purposes, and is not intended to be limiting, as any of components 108, 110, 112, 114, and/or 116 may provide more or less functionality than is described. For example, one or more of components 108, 110, 112, 114, and/or 116 may be eliminated, and some or all of its functionality may be provided by other ones of components 108, 110, 112, 114, and/or 116. As an example, processor(s) 134 may be configured to execute one or more additional components that may perform some or all of the functionality attributed below to one of components 108, 110, 112, 114, and/or 116.

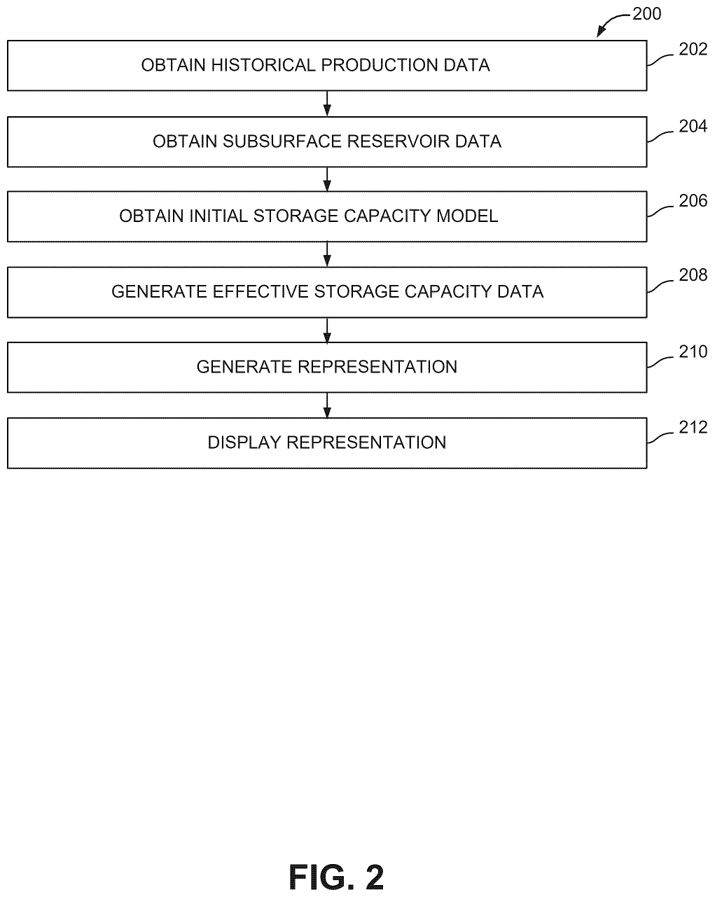

FIG. 2 illustrates a method for determining an effective storage capacity of an unconventional subsurface volume of interest as a function of position, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a physical computer processor, a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on a non-transitory storage medium. The one or more processing devices may include one or more devices configured through hardware, firmware, and/or software to be specifically designed for execution of one or more of the operations of method 200.

Operation 202 may include obtaining historical production data. The historical production data may correlate to an amount of produced fluid from the unconventional subsurface volume of interest as a function of position. Operation 202 may be performed by a physical computer processor configured by machine-readable instructions including a component that is the same as or similar to historical production component 108 in accordance with one or more implementations.

Operation 204 may include obtaining subsurface reservoir data. The subsurface reservoir data may correlate to petrophysical and geochemical characteristics of the unconventional subsurface volume of interest as a function of position. Operation 204 may be performed by a physical computer processor configured by machine-readable instructions including a component that is the same as or similar to subsurface reservoir component 110 in accordance with one or more implementations.

Operation 206 may include obtaining an initial storage capacity model that includes initial forecast production data correlating to the unconventional subsurface volume of interest. The initial storage capacity model may include subsurface characterization parameters. The subsurface characterization parameters may correlate to reservoir characteristics of the unconventional subsurface volume of interest. The subsurface characterization parameters may include core-based data, petrophysical data, geochemical data, and/or geophysical data. The reservoir characteristics may include one of rock fluid data, pressure data, chemical property data, and/or physical property data. The initial storage capacity model is based on mobility, buoyancy, reservoir heterogeneity, and/or water saturation. Operation 206 may be performed by a physical computer processor configured by machine-readable instructions including a component that is the same as or similar to autocorrelation correction factor component 112 in accordance with one or more implementations.

Operation 208 may include generating effective storage capacity data. The effective storage capacity data may be generated by adjusting the initial forecast production data of the initial storage capacity model using the historical production data, the subsurface reservoir data, or both. The effective storage capacity data may correlate to an available storage volume of the unconventional subsurface volume of interest as a function of position. Operation 208 may be performed by a physical computer processor configured by machine-readable instructions including a component that is the same as or similar to effective storage capacity component 114, in accordance with one or more implementations.

Operation 210 may include generating a graphical representation of the effective storage capacity of the unconventional subsurface volume of interest as a function of position. The graphical representation may use visual effects to depict at least a portion of the effective storage capacity data. Operation 210 may be performed by a physical computer processor configured by machine-readable instructions including a component that is the same as or similar to representation component 116, in accordance with one or more implementations.

Operation 212 may include displaying the graphical representation. Operation 218 may be performed by a physical computer processor configured by machine-readable instructions including a component that is the same as or similar to representation component 116, in accordance with one or more implementations.

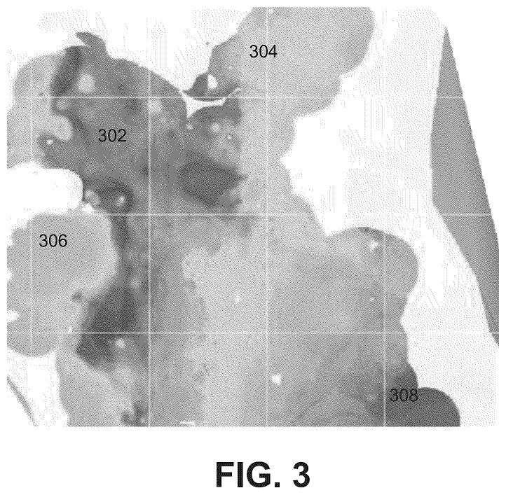

FIG. 3 illustrates a representation of effective storage capacity of an unconventional subsurface volume of interest as a function of position, in accordance with one or more implementations. Representation 300 may use different shades to indicate the effective storage capacity of an unconventional subsurface volume of interest as a function of position. For example, region 302 may represent the highest effective storage capacity in this unconventional subsurface volume of interest. Region 304 may represent a high effective storage capacity in this unconventional subsurface volume of interest. Region 306 may represent a medium effective storage capacity in this unconventional subsurface volume of interest. Region 308 may represent the lowest effective storage capacity in this unconventional subsurface volume of interest. It should be appreciated that this is a random distribution used to depict a potential range of effective storage capacity in an unconventional subsurface volume of interest that may be appropriate for a given situation, and they are not limiting.

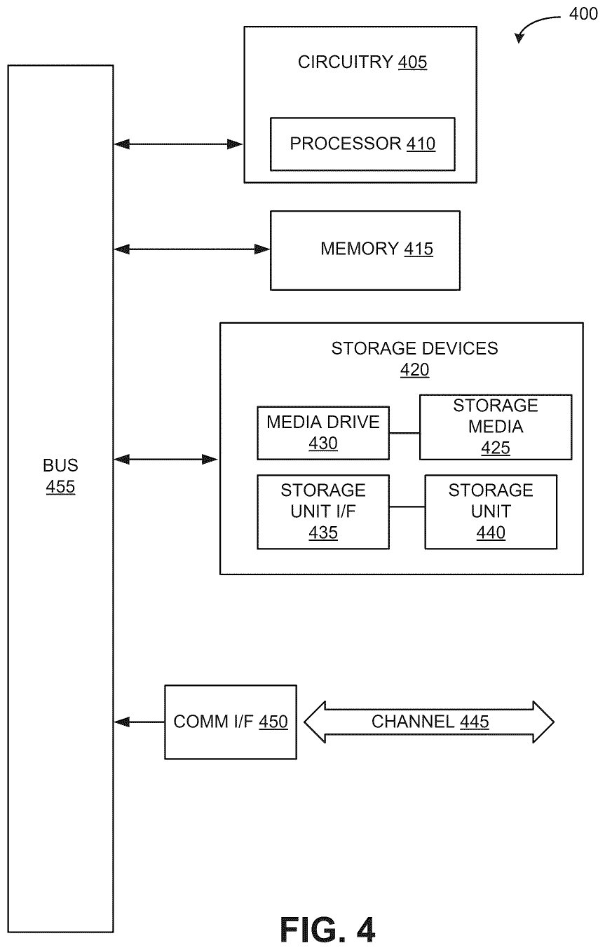

FIG. 4 illustrates example computing component 400, which may in some instances include a processor/controller resident on a computer system (e.g., server system 106). Computing component 400 may be used to implement various features and/or functionality of implementations of the systems, devices, and methods disclosed herein. With regard to the above-described implementations set forth herein in the context of systems, devices, and methods described with reference to FIGS. 1 through 3, including implementations involving server(s) 102, it may be appreciated additional variations and details regarding the functionality of these implementations that may be carried out by computing component 400. In this connection, it will also be appreciated upon studying the present disclosure that features and aspects of the various implementations (e.g., systems) described herein may be implemented with respect to other implementations (e.g., methods) described herein without departing from the spirit of the disclosure.

As used herein, the term component may describe a given unit of functionality that may be performed in accordance with some implementations of the present application. As used herein, a component may be implemented utilizing any form of hardware, software, or a combination thereof. For example, a processor, controller, ASIC, PLA, PAL, CPLD, FPGA, logical component, software routine, or other mechanism may be implemented to make up a component. In implementation, the various components described herein may be implemented as discrete components or the functions and features described may be shared in part or in total among components. In other words, it should be appreciated that after reading this description, the various features and functionality described herein may be implemented in any given application and may be implemented in separate or shared components in various combinations and permutations. Even though various features or elements of functionality may be individually described or claimed as separate components, it will be appreciated that upon studying the present disclosure that these features and functionality may be shared among a common software and hardware element, and such description shall not require or imply that separate hardware or software components are used to implement such features or functionality.

Where components of the application are implemented in whole or in part using software, in implementations, these software elements may be implemented to operate with a computing or processing component capable of carrying out the functionality described with respect thereto. One such example computing component is shown in FIG. 4. Various implementations are described in terms of example computing component 400. After reading this description, it will be appreciated how to implement example configurations described herein using other computing components or architectures.

Referring now to FIG. 4, computing component 400 may represent, for example, computing or processing capabilities found within mainframes, supercomputers, workstations or servers; desktop, laptop, notebook, or tablet computers; hand-held computing devices (tablets, PDA's, smartphones, cell phones, palmtops, etc.); or the like, depending on the application and/or environment for which computing component 400 is specifically purposed.

Computing component 400 may include, for example, a processor, physical computer processor, controller, control component, or other processing device, such as a processor 410, and such as may be included in circuitry 405. Processor 410 may be implemented using a special-purpose processing engine such as, for example, a microprocessor, controller, or other control logic. In the illustrated example, processor 410 is connected to bus 455 by way of circuitry 405, although any communication medium may be used to facilitate interaction with other components of computing component 400 or to communicate externally.

Computing component 400 may also include a memory component, simply referred to herein as main memory 415. For example, random access memory (RAM) or other dynamic memory may be used for storing information and instructions to be executed by processor 410 or circuitry 405. Main memory 415 may also be used for storing temporary variables or other intermediate information during execution of instructions to be executed by processor 410 or circuitry 405. Computing component 400 may likewise include a read only memory (ROM) or other static storage device coupled to bus 455 for storing static information and instructions for processor 410 or circuitry 405.

Computing component 400 may also include various forms of information storage devices 420, which may include, for example, media drive 430 and storage unit interface 435. Media drive 430 may include a drive or other mechanism to support fixed or removable storage media 425. For example, a hard disk drive, a floppy disk drive, a magnetic tape drive, an optical disk drive, a CD or DVD drive (R or RW), or other removable or fixed media drive may be provided. Accordingly, removable storage media 425 may include, for example, a hard disk, a floppy disk, magnetic tape, cartridge, optical disk, a CD or DVD, or other fixed or removable medium that is read by, written to, or accessed by media drive 430. As these examples illustrate, removable storage media 425 may include a computer usable storage medium having stored therein computer software or data.

In alternative implementations, information storage devices 420 may include other similar instrumentalities for allowing computer programs or other instructions or data to be loaded into computing component 400. Such instrumentalities may include, for example, fixed or removable storage unit 440 and storage unit interface 435. Examples of such removable storage units 440 and storage unit interfaces 435 may include a program cartridge and cartridge interface, a removable memory (for example, a flash memory or other removable memory component) and memory slot, a PCMCIA slot and card, and other fixed or removable storage units 440 and storage unit interfaces 435 that allow software and data to be transferred from removable storage unit 440 to computing component 400.

Computing component 400 may also include a communications interface 440. Communications interface 440 may be used to allow software and data to be transferred between computing component 400 and external devices. Examples of communications interface 440 include a modem or soft modem, a network interface (such as an Ethernet, network interface card, WiMedia, IEEE 402.XX, or other interface), a communications port (such as for example, a USB port, IR port, RS232 port Bluetooth® interface, or other port), or other communications interface. Software and data transferred via communications interface 440 may typically be carried on signals, which may be electronic, electromagnetic (which includes optical) or other signals capable of being exchanged by a given communications interface 440. These signals may be provided to/from communications interface 440 via channel 445. Channel 445 may carry signals and may be implemented using a wired or wireless communication medium. Some non-limiting examples of channel 445 include a phone line, a cellular or other radio link, an RF link, an optical link, a network interface, a local or wide area network, and other wired or wireless communications channels.

In this document, the terms “computer program medium” and “computer usable medium” are used to generally refer to transitory or non-transitory media such as, for example, main memory 415, storage unit interface 435, removable storage media 425, and channel 445. These and other various forms of computer program media or computer usable media may be involved in carrying a sequence of instructions to a processing device for execution. Such instructions embodied on the medium, are generally referred to as “computer program code” or a “computer program product” (which may be grouped in the form of computer programs or other groupings). When executed, such instructions may enable the computing component 400 or a processor to perform features or functions of the present application as discussed herein.

Various implementations have been described with reference to specific example features thereof. It will, however, be evident that various modifications and changes may be made thereto without departing from the broader spirit and scope of the various implementations as set forth in the appended claims. The specification and figures are, accordingly, to be regarded in an illustrative rather than a restrictive sense.

Although described above in terms of various example implementations and implementations, it should be understood that the various features, aspects, and functionality described in one of the individual implementations are not limited in their applicability to the particular implementation with which they are described, but instead may be applied, alone or in various combinations, to other implementations of the present application, whether or not such implementations are described and whether or not such features are presented as being a part of a described implementation. Thus, the breadth and scope of the present application should not be limited by any of the above-described example implementations.

Terms and phrases used in the present application, and variations thereof, unless otherwise expressly stated, should be construed as open ended as opposed to limiting. As examples of the foregoing: the term “including” should be read as meaning “including, without limitation,” or the like; the term “example” is used to provide illustrative instances of the item in discussion, not an exhaustive or limiting list thereof; the terms “a” or “an” should be read as meaning “at least one,” or the like; and adjectives such as “standard,” “known,” and terms of similar meaning should not be construed as limiting the item described to a given time period or to an item available as of a given time, but instead should be read to encompass standard technologies that may be available or known now or at any time in the future. Likewise, where this document refers to technologies that would be appreciated to one of ordinary skill in the art, such technologies encompass that which would be appreciated by the skilled artisan now or at any time in the future.

The presence of broadening words and phrases such as “at least,” “but not limited to,” or other like phrases in some instances shall not be read to mean that the narrower case is intended or required in instances where such broadening phrases may be absent. The use of the term “component” does not imply that the components or functionality described or claimed as part of the component are all configured in a common package. Indeed, any or all of the various components of a component, whether control logic or other components, may be combined in a single package or separately maintained and may further be distributed in multiple groupings or packages or across multiple locations.

The use of the terms “about”, “approximately”, and similar terms applies to all numeric values, whether or not explicitly indicated. These terms generally refer to a range of numbers that one of ordinary skill in the art would consider as a reasonable amount of deviation to the recited numeric values (i.e., having the equivalent function or result). For example, this term may be construed as including a deviation of +10 percent of the given numeric value provided such a deviation does not alter the end function or result of the value. Therefore, a value of about 1% may be construed to be a range from 0.9% to 1.1%. Furthermore, a range may be construed to include the start and the end of the range. For example, a range of 10% to 20% (i.e., range of 10%-20%) includes 10% and also includes 20%, and includes percentages in between 10% and 20%, unless explicitly stated otherwise herein. Similarly, a range of between 10% and 20% (i.e., range between 10%-20%) includes 10% and also includes 20%, and includes percentages in between 10% and 20%, unless explicitly stated otherwise herein.

It is understood that when combinations, subsets, groups, etc. of elements are disclosed (e.g., combinations of items in a composition, or combinations of steps in a method), that while specific reference of each of the various individual and collective combinations and permutations of these elements may not be explicitly disclosed, each is specifically contemplated and described herein. By way of example, if an item is described herein as including an item of type A, an item of type B, an item of type C, or any combination thereof, it is understood that this phrase describes all of the various individual and collective combinations and permutations of these items. For example, in some embodiments, the item described by this phrase could include only an item of type A. In some embodiments, the item described by this phrase could include only an item of type B. In some embodiments, the item described by this phrase could include only an item of type C. In some embodiments, the item described by this phrase could include an item of type A and an item of type B. In some embodiments, the item described by this phrase could include an item of type A and an item of type C. In some embodiments, the item described by this phrase could include an item of type B and an item of type C. In some embodiments, the item described by this phrase could include an item of type A, an item of type B, and an item of type C. In some embodiments, the item described by this phrase could include two or more items of type A (e.g., A1 and A2). In some embodiments, the item described by this phrase could include two or more items of type B (e.g., B1 and B2). In some embodiments, the item described by this phrase could include two or more items of type C (e.g., C1 and C2). In some embodiments, the item described by this phrase could include two or more of a first item (e.g., two or more items of type A (A1 and A2)), optionally one or more of a second item (e.g., optionally one or more items of type B), and optionally one or more of a third item (e.g., optionally one or more items of type C). In some embodiments, the item described by this phrase could include two or more of a first item (e.g., two or more items of type B (B1 and B2)), optionally one or more of a second item (e.g., optionally one or more items of type A), and optionally one or more of a third item (e.g., optionally one or more items of type C). In some embodiments, the item described by this phrase could include two or more of a first item (e.g., two or more items of type C (C1 and C2)), optionally one or more of a second item (e.g., optionally one or more items of type A), and optionally one or more of a third item (e.g., optionally one or more items of type B).

Additionally, the various implementations set forth herein are described in terms of example block diagrams, flow charts, and other illustrations. As will be appreciated after reading this document, the illustrated implementations and their various alternatives may be implemented without confinement to the illustrated examples. For example, block diagrams and their accompanying description should not be construed as mandating a particular architecture or configuration.

What is claimed is:

1. A method for determining an effective storage capacity of an unconventional subsurface volume of interest as a function of position, the method being implemented in a computer system that includes a physical computer processor, a graphical user interface, and a non-transitory storage medium, the method comprising:
obtaining historical production data correlating to the unconventional subsurface volume of interest from the non-transitory storage medium, wherein the historical production data correlates to an amount of produced fluid as a function of position;
obtaining subsurface reservoir data correlating to the unconventional subsurface volume of interest from the non-transitory storage medium;
obtaining an initial storage capacity model comprising initial forecast production data correlating to the unconventional subsurface volume of interest from the non-transitory storage medium, wherein the initial storage capacity model comprises subsurface characterization parameters, wherein the subsurface characterization parameters correlate to reservoir characteristics of the unconventional subsurface volume of interest, and wherein the initial forecast production data correlates to a forecasted amount of produced fluid as a function of position;
adjusting, with the physical computer processor, the initial forecast production data of the initial storage capacity model using the historical production data, the subsurface reservoir data, or both to generate effective storage capacity data of the unconventional subsurface volume of interest as a function of position;
generating, with the physical computer processor, a graphical representation of the effective storage capacity of the unconventional subsurface volume of interest as a function of position using visual effects to depict at least a portion of the effective storage capacity data; and
displaying the graphical representation in the graphical user interface.

2. The method of claim 1, wherein the initial storage capacity model is based on mobility, buoyancy, reservoir heterogeneity, water saturation, or any combination thereof.

3. The method of claim 1, wherein the subsurface reservoir data correlates to petrophysical and geochemical characteristics as a function of position.

4. The method of claim 1, wherein the subsurface characterization parameters comprise core-based data, petrophysical data, geochemical data, geophysical data, or any combination thereof.

5. The method of claim 1, wherein the reservoir characteristics comprise rock fluid data, pressure data, chemical property data, physical property data, or any combination thereof.

6. The method of claim 1, wherein the effective storage capacity data correlates to an available storage volume in the unconventional subsurface volume of interest as a function of position for carbon dioxide.

7. The method of claim 1, wherein the effective storage capacity data correlates to an available storage volume in the unconventional subsurface volume of interest as a function of position for a fluid storable in the unconventional subsurface volume of interest.

8. A system comprising:
a non-transitory storage medium;
a graphical user interface; and
a physical computer processor configured by machine-readable instructions to:
obtain historical production data correlating to an unconventional subsurface volume of interest from the non-transitory storage medium, wherein the historical production data correlates to an amount of produced fluid as a function of position;
obtain subsurface reservoir data correlating to the unconventional subsurface volume of interest from the non-transitory storage medium;
obtain an initial storage capacity model comprising initial forecast production data correlating to the unconventional subsurface volume of interest from the non-transitory storage medium, wherein the initial storage capacity model comprises subsurface characterization parameters, wherein the subsurface characterization parameters correlate to reservoir characteristics of the unconventional subsurface volume of interest, and wherein the initial forecast production data correlates to a forecasted amount of produced fluid as a function of position;
adjust, with the physical computer processor, the initial forecast production data of the initial storage capacity model using the historical production data, the subsurface reservoir data, or both to generate effective storage capacity data of the unconventional subsurface volume of interest as a function of position;
generate, with the physical computer processor, a graphical representation of an effective storage capacity of the unconventional subsurface volume of interest as a function of position using visual effects to depict at least a portion of the effective storage capacity data; and
display the graphical representation in the graphical user interface.

9. The system of claim 8, wherein the initial storage capacity model is based on mobility, buoyancy, reservoir heterogeneity, water saturation, or any combination thereof.

10. The system of claim 8, wherein the subsurface reservoir data correlates to petrophysical and geochemical characteristics as a function of position.

11. The system of claim 8, wherein the subsurface characterization parameters comprise core-based data, petrophysical data, geochemical data, geophysical data, or any combination thereof.

12. The system of claim 8, wherein the reservoir characteristics comprise rock fluid data, pressure data, chemical property data, physical property data, or any combination thereof.

13. The system of claim 8, wherein the effective storage capacity data correlates to an available storage volume in the unconventional subsurface volume of interest as a function of position for carbon dioxide.

14. The system of claim 8, wherein the effective storage capacity data correlates to an available storage volume in the unconventional subsurface volume of interest as a function of position for a fluid storable in the unconventional subsurface volume of interest.

15. A non-transitory computer-readable medium storing instructions for determining an effective storage capacity of an unconventional subsurface volume of interest as a function of position, the instructions configured to, when executed:
obtain historical production data correlating to the unconventional subsurface volume of interest from a non-transitory storage medium, wherein the historical production data correlates to an amount of produced fluid as a function of position;
obtain subsurface reservoir data correlating to the unconventional subsurface volume of interest from the non-transitory storage medium;
obtain an initial storage capacity model comprising initial forecast production data correlating to the unconventional subsurface volume of interest from the non-transitory storage medium, wherein the initial storage capacity model comprises subsurface characterization parameters, wherein the subsurface characterization parameters correlate to reservoir characteristics of the unconventional subsurface volume of interest, and wherein the initial forecast production data correlates to a forecasted amount of produced fluid as a function of position;
adjust, with a physical computer processor, the initial forecast production data of the initial storage capacity model using the historical production data, the subsurface reservoir data, or both to generate effective storage capacity data of the unconventional subsurface volume of interest as a function of position;
generate, with the physical computer processor, a graphical representation of the effective storage capacity of the unconventional subsurface volume of interest as a function of position using visual effects to depict at least a portion of the effective storage capacity data; and
display the graphical representation in a graphical user interface.

16. The non-transitory computer-readable medium of claim 15, wherein the initial storage capacity model is based on mobility, buoyancy, reservoir heterogeneity, water saturation, or any combination thereof.

17. The non-transitory computer-readable medium of claim 15, wherein the subsurface reservoir data correlates to petrophysical and geochemical characteristics as a function of position.

18. The non-transitory computer-readable medium of claim 15, wherein the subsurface characterization parameters comprise core-based data, petrophysical data, geochemical data, geophysical data, or any combination thereof.

19. The non-transitory computer-readable medium of claim 15, wherein the reservoir characteristics comprise rock fluid data, pressure data, chemical property data, physical property data, or any combination thereof.

20. The non-transitory computer-readable medium of claim 15, wherein the effective storage capacity data correlates to an available storage volume in the unconventional subsurface volume of interest as a function of position for carbon dioxide.

21. The non-transitory computer-readable medium of claim 15, wherein the effective storage capacity data correlates to an available storage volume in the unconventional subsurface volume of interest as a function of position for a fluid storable in the unconventional subsurface volume of interest.
